(19) United States
(12) Patent Application Publication
(10) Pub. No.: US 2013/0162111 A1
(43) Pub. Date: Jun. 27, 2013

(54) SPINDLE MOTOR

(71) Applicant: SAMSUNG ELECTRO-MECHANICS CO., LTD., Suwon (KR)

(72) Inventor: Yong Sik Kim, Suwon (KR)

(73) Assignee: SAMSUNG ELECTRO-MECHANICS CO., LTD., Suwon (KR)

(21) Appl. No.: 13/716,918

(22) Filed: Dec. 17, 2012

(30) Foreign Application Priority Data
Dec. 23, 2011 (KR) 10-2011-0140918

(51) Int. Cl. H02K 5/167

(52) U.S. Cl. CPC H02K 5/167
USPC 310/425

(57) ABSTRACT

Disclosed herein is a spindle motor, including: a shaft forming the center of rotation of a rotor; a sleeve receiving the shaft therein and rotatably supporting the shaft; a base coupled to an outer side surface of the sleeve so as to support the sleeve; and a conductive adhesive applied to a coupled surface between the sleeve and the base. According to the present invention, the conductive adhesive is used at the time of adhering between the sleeve and the base of the spindle motor, thereby making it possible to discharge excessive electric charges generated at the time of driving the spindle motor to the outside through the base.

### CROSS REFERENCE TO RELATED APPLICATION

This application claims the benefit of Korean Patent Application No. 10-2011-0140918, filed on Dec. 23, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor which belongs to a brushless-DC motor (BLDC) has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, a spindle motor including a hydrodynamic bearing having lower driving friction as compared to an existing ball bearing has generally been used in order to minimize generation of noise and non repeatable run out (NRRO), which is vibration generated at the time of use of a ball bearing. In the hydrodynamic bearing, a thin oil film is basically formed between a rotor and a stator, such that the rotor and the stator are supported by pressure generated at the time of rotation. Therefore, the rotor and stator do not contact each other, such that frictional load is reduced. In the spindle motor using the hydrodynamic bearing, lubricating oil (hereinafter, referred to as an ‘operating fluid) maintains a shaft of the motor rotating a disk only with dynamic pressure (pressure returning oil pressure to the center by centrifugal force of the shaft). Therefore, the spindle motor using the hydrodynamic bearing is distinguished from a ball bearing spindle motor in that the shaft is supported by a shaft ball made of iron.

When the hydrodynamic bearing is used in the spindle motor, the rotor is supported by the fluid, such that a noise amount generated in the motor is small, power consumption is low, and impact resistance is excellent.

In the spindle motor according to the prior art, a bearing part including a sleeve and a base have been generally adhered to each other by a bonding process. Particularly, since an ultraviolet (UV) adhesive is easily applied and easily cured, it has been mainly used. However, since most of the adhesives used in the prior art including the UV adhesive have insulating characteristics, there is a problem that a process of bonding a conductive adhesive is additionally required. In addition, in the case of bonding a separate conductive adhesive, there is a problem that the conductive adhesive is easily separated. Due to these problems, various errors are generated when a recording medium such as a hard disk, or the like, stores or records data in a disk.

### SUMMARY OF THE INVENTION

The present invention has been made in an effort to provide a spindle motor capable of minimizing an error generated at the time of recording and storing data through a recording medium such as a disk, or the like, by using a conductive adhesive at the time of coupling a sleeve and a base configuring a bearing part.

According to a preferred embodiment of the present invention, there is provided a spindle motor including: a shaft forming the center of rotation of a rotor; a sleeve receiving the shaft therein and rotatably supporting the shaft; a base coupled to an outer side surface of the sleeve so as to support the sleeve; and a conductive adhesive applied to a coupled surface between the sleeve and the base.

The conductive adhesive may be an anisotropic conductive film (ACF) applied in a solution state.

The ACF may be applied to the coupled surface between the sleeve and the base to bond therebetween by a thermo-compression method.

The thermo-compression method may be performed in a range of 250 to 300° C.

The ACF may be applied to the coupled surface between the sleeve and the base and has a vertical ultrasonic wave applied thereto, such that heat is spontaneously generated, thereby bonding between the sleeve and the base.

The ACF in the solution state may be applied to a bonded surface of the sleeve or the base in a dispensing or spray scheme.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded view of a sleeve and a base of a spindle motor according to a preferred embodiment of the present invention;

FIG. 2 is a view showing a process of applying a conductive adhesive at the time of coupling the sleeve and the base of the spindle motor according to the preferred embodiment of the present invention to each other; and

FIG. 3 is a cross-sectional view of the spindle motor according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

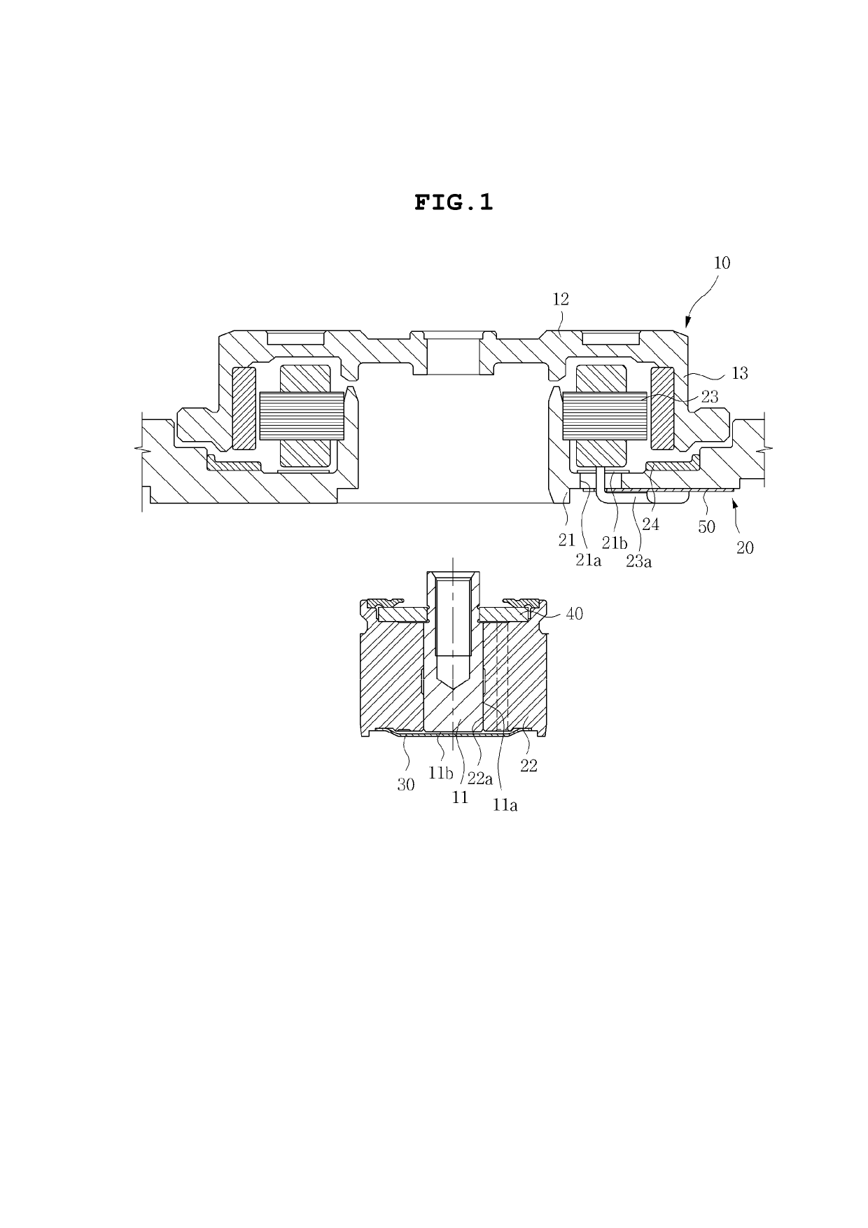

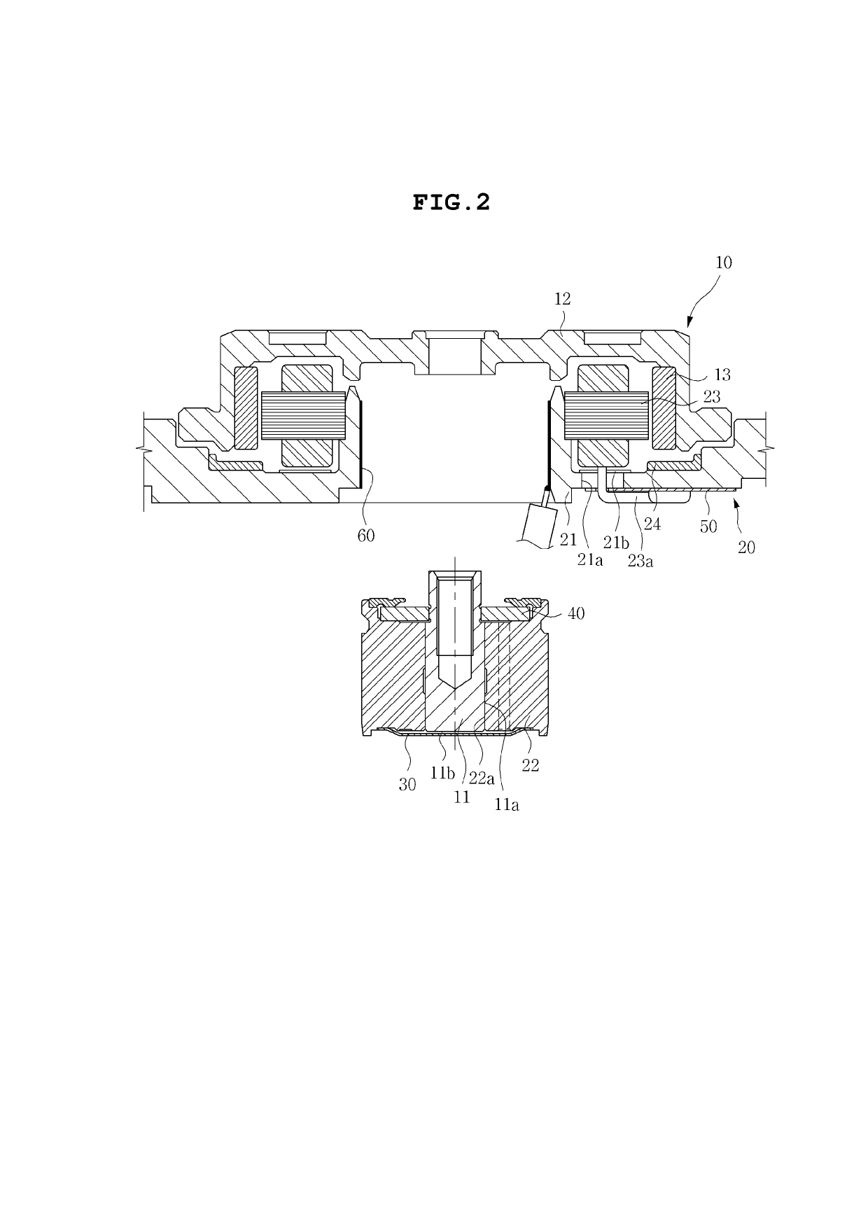

FIG. 1 is an exploded view of a sleeve 22 and a base 21 of a spindle motor according to a preferred embodiment of the present invention; and FIG. 2 is a view showing a process of applying a conductive adhesive at the time of coupling the sleeve 22 and the base 21 of the spindle motor according to the preferred embodiment of the present invention to each other.

The spindle motor according to the preferred embodiment of the present invention is configured to include a shaft 11 forming the center of rotation of a rotor, a sleeve 22 receiving the shaft 11 therein and rotatably supporting the shaft 11, a base 21 coupled to an outer side surface of the sleeve 22 so as to support the sleeve 22, and a conductive adhesive 60 applied to a coupled surface between the sleeve 22 and the base 21.

The shaft 11 forms a central axis around which the spindle motor rotates and has generally a cylindrical shape. A thrust plate 40 for forming a thrust dynamic pressure bearing part by a hydrodynamic bearing may be insertedly installed so as to be orthogonal to an upper side portion of the shaft 11. Here, the thrust plate 40 may be formed at the upper side portion of the shaft 11 and be insertedly installed so as to be orthogonal to a lower end portion of the shaft 11. In order to fix the thrust plate 40 to the shaft 11, separate laser welding, or the like, may be performed. However, it is obvious to those skilled in the art that the thrust plate 40 may be press-fitted into and be coupled to the shaft 11 by being applied with predetermined pressure. The thrust plate 40 may include a dynamic pressure generation groove (not shown) formed therein in order to form the thrust dynamic pressure bearing part by the hydrodynamic bearing.

The sleeve 22 may receive the shaft 11 therein and have a hollow cylindrical shape so as to rotatably support the shaft 11, and radial dynamic pressure bearing parts may be formed in an outer peripheral surface 11a of the shaft 11 and an inner peripheral surface 22a of the sleeve 22 coupled to each other, by oil which is an operating fluid. In addition, a dynamic pressure generation groove (not shown) of the radial dynamic pressure bearing part for generating dynamic pressure may be formed in any one of the outer peripheral surface 11a of the shaft 11 or the inner peripheral surface 22a of the sleeve 22 forming the radial dynamic pressure bearing part.

The conductive adhesive 60 is applied to the coupled surface between the sleeve 22 and the base 21. Generally, in the case of recording and storing data using a magnetic disk, when there is electrical interference or effect, an error is generated in recording and storing the data. Particularly, since a hard disk driver (HDD) also uses the magnetic disk as a storage medium, the same problem as the problem described above is generated. In order to solve this problem, a process such as a process of separately forming the conductive adhesive 60 at a distal end of a coupled portion between the base 21 and the sleeve 22, or the like, has been added in the prior art. Therefore, a lead time has increased, and the conductive adhesive 60 has been separated due to external impact, or the like.

According to the preferred embodiment, the conductive adhesive 60 rather than the adhesive having insulating characteristics according to the prior art is directly applied to the coupled surface between the sleeve 22 and the base 21, thereby solving the above-mentioned problems. Particularly, the conductive adhesive 60 used in the preferred embodiment of the present invention may be applied in a scheme in which an anisotropic conductive film (ACF) is manufactured in a solution state rather than a film state and then applied in a dispensing method or a spray method. The ACF, which is the conductive adhesive 60, is applied to the coupled surface between the sleeve 22 and the base 21, such that excessive electric charges generated at the time of driving the spindle motor are discharged to the base 21 through the ACF, which is the conductive adhesive 60, without being excessively accumulated in the bearing part, thereby making it possible to smoothly record and store the data in the disk at the time of driving the spindle motor.

The ACF is an anisotropic conductive film in which fine conductive particles are mixed with an adhesive resin (generally, a thermosetting resin) to thereby be manufactured in a film state and be electrified only in one direction. As the fine conductive particle, there are Ni, carbon, and a solder ball. The present invention is characterized in that the ACF in the solution state rather than the film state is applied to the bonded surface between the sleeve 22 and the base 21.

Here, a method of bonding the sleeve 22 and the base 21 to each other using the ACF for electric conduction therebetween may be performed as a method utilizing a property of the ACF, that is, a property of the ACF hardened when heat and pressure is applied thereto. As this method, there are a thermo-compression method, which is a method of applying heat from the outside, and a method utilizing an ultrasonic wave allowing heat to be spontaneously generated at the inside.

More specifically, when the ACF is applied to the coupled surface between the sleeve 22 and the base 21 to bond therebetween by the thermo-compression method, the sleeve 22 and the base 21 are bonded to each other at a temperature of 250 to 300° C. within 15 seconds using a hot bar in a compressing and heating scheme. In this case, an internal temperature of the ACF is within 190° C. Particularly, in the case in which a temperature at which the sleeve 22 and the base 21 are bonded to each other using the hot bar is low (for example, less than a range of 250 to 300° C.), bonding force is weakened, and in the case in which the temperature exceeds the above range, a property, or the like, of the ACF is changed, such that reliability of the bonding is deteriorated.

In addition, when the ACF is applied to the coupled surface between the sleeve 22 and the base 21 to bond therebetween using an ultrasonic wave, a pre-bonding process and a main-bonding process are separately performed. The pre-bonding process is a process of applying the ACF to the bonded surface of the sleeve 22 or the base 21, and the main-bonding process is a process of bonding the bonded surface of the sleeve 22 or the base 21 to which the ACF is not applied. In both of the pre-bonding process and the main-bonding process, the sleeve 22 and the base 21 are bonded to each other by applying the ultrasonic wave. As shown in FIG. 2, after the pre-bonding process of applying the ACF to the bonded surface of the base 21 is performed, the sleeve 22 is bonded to the base 21. In this case, the bonding process is performed by applying the ultrasonic wave. A process of repairing the bonded portion is as follows. First, the ultrasonic wave is applied to a bonded portion between the base 21 and the sleeve 22 to heat the bonded portion at a temperature of about 120° C., thereby making the ACF unhardened. Then, the sleeve 22 is separated from the base 21, and an ACF solution is removed using a repair solution or acetone. Thereafter, the sleeve 22 and the base 21 are bonded to each other by a new bonding process, thereby making it possible to correct an erroneous bonding process.

In addition, the spindle motor according to the preferred embodiment of the present invention further includes the base 21 coupled to an outer side surface of the sleeve 22 so as to support the sleeve 22 and having a core 23 mounted on an inner side surface thereof, the core 23 having a coil 23a wound therearound; and a hub 12 having the shaft 11 coupled integrally therewith at a central portion thereof and having a rotor magnet 13 formed at a position corresponding to that of the core 23.

The base 21 has one side surface coupled to the outer side surface of the sleeve 22 so that the sleeve 22 including the shaft 11 is coupled to an inner side thereof. The base 21 has the core 23 coupled to the other side surface thereof, which is an opposite side to one side surface thereof, at a position corresponding to that of the rotor magnet 13 formed on the hub 12, wherein the core 23 has a winding coil wound therearound. The base 21 may serve to support the entire structure of the spindle motor at a lower portion of the spindle motor and be manufactured by press processing or die-casting. In the case in which the base 21 is manufactured by the press processing, the base 21 may be made of various metal materials such as aluminum, steel, and the like, particularly, a material having rigidity.

As described above, the conductive adhesive 60 is applied to the bonded surface between the base 21 and the sleeve 22 to allow excessive charges generated at the time of an operation of the spindle motor to flow out through the base 21, thereby making it possible to improve reliability of the operation of the motor.

The core 23 is generally formed by stacking a plurality of thin metal plates and is fixedly disposed on the base 21 including a flexible printed circuit board 50. A plurality of through-holes 21a may be formed in a lower end surface of the base 21 so as to correspond to the coil 23a led from the winding coil 23a, and the coil 23a led through the through-holes 21a may be soldered and electrically connected to the flexible printed circuit board 50. An insulating sheet 21b may be formed at an inlet portion of the through-hole 21a in order to insulate the through-hole 21a and the coil 23a passing through the through-hole 21a from each other.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in an axial direction. The rotor magnet 13 is formed so as to correspond to a core 23 of a base 21 to be described in a radial direction. The core 23 generates a magnetic flux while forming a magnetic field when current flows. The rotor magnet 13 facing the core 23 includes repeatedly magnetized N. and S. poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

In addition, the spindle motor according to the preferred embodiment of the present invention may further include a cover member 30 covering a lower edge of the sleeve 22 in the axial direction. The cover member 30 is coupled to the sleeve 22 in order to cover a lower end surface of the sleeve 22 in the axial direction as well as the shaft 11. The cover member 30 includes a dynamic pressure generation groove (not shown) formed in an inner side surface thereof facing the lower end surface 11b of the shaft 11, thereby making it possible to form a thrust dynamic pressure bearing part. The cover member 30 may have a structure in which it is coupled to a distal end of the sleeve 22, such that the oil, which is the operating fluid, may be stored therein.

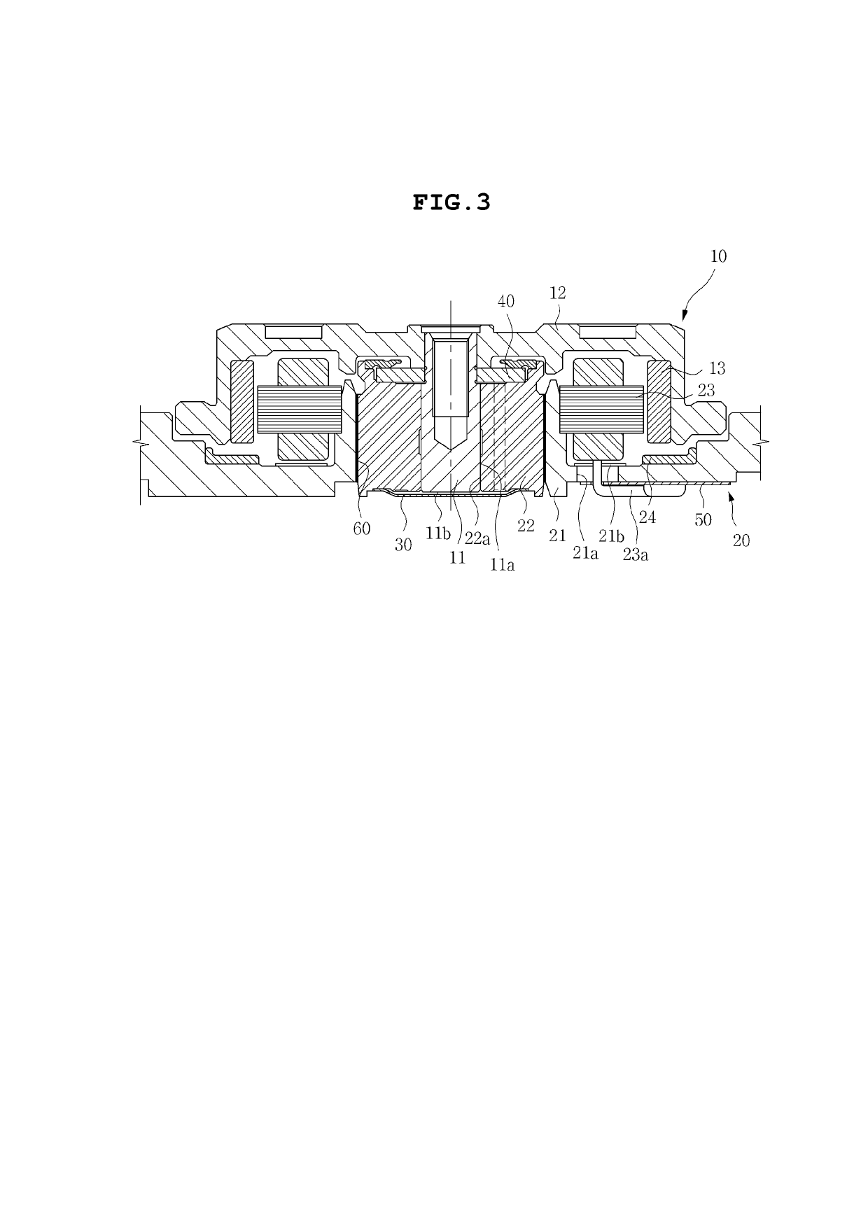

FIG. 3 is a cross-sectional view of the spindle motor according to the preferred embodiment of the present invention.

Components of the spindle motor according to the preferred embodiment of the present invention and an operation relationship therebetween will be briefly described below with reference to FIG. 3.

A rotor 10 includes the shaft 11 becoming a rotation axis and rotatably formed and the hub 12 having the rotor magnet 13 attached thereto, and a stator 20 includes the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N. and S. poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving the spindle motor, the pulling plate 24 is formed on the base 21 so as to correspond to the rotor magnet 13 in the axial direction. The pulling plate 24 and the rotor magnet 13 have attractive force acting therebetween, thereby making it possible to stably rotate the spindle motor. Particularly, according to the preferred embodiment of the present invention, the conductive adhesive 60 is applied to the bonded surface between the base 21 and the sleeve 22 to allow excessive charges generated at the time of the operation of the spindle motor to flow out through the base 21, such that an error in operations such as recording, storing, and the like, of the magnetic disk is minimized, thereby making it possible to improve reliability of a product.

According to the preferred embodiment of the present invention, the conductive adhesive is used at the time of adhering between the sleeve and the base of the spindle motor, thereby making it possible to discharge excessive electric charges generated at the time of driving the spindle motor to the outside through the base.

In addition, the conductive adhesive is used at the time of adhering between the sleeve and the base of the spindle motor to discharge the excessive electric charges generated at the time of driving the spindle motor to the outside through the base, thereby making it possible to prevent an error at the time of recording or storing data in the magnetic disk.

Further, the error at the time of recording or storing data in the magnetic disk is prevented, thereby making it possible to improve reliability of a disk drive product including the spindle motor and reliability of an operation thereof.

Moreover, the conductive adhesive is used at the time of adhering between the sleeve and the base of the spindle motor, such that a process of applying a separate conductive adhesive is omitted, thereby making it possible to improve reliability of product assembling and a motor function and mass-product the product.

Furthermore, the ACF in the solution state is used as the conductive adhesive at the time of adhering between the sleeve and the base of the spindle motor, thereby making it possible to decrease an adhering time, improve adhesion, and simplify other applying processes.

Furthermore, the ACF in the solution state is used as the conductive adhesive at the time of adhering between the sleeve and the base of the spindle motor, thereby making it possible to increase a sealing effect from external foreign materials.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft forming the center of rotation of a rotor;
a sleeve receiving the shaft therein and rotatably supporting the shaft;
a base coupled to an outer side surface of the sleeve so as to support the sleeve; and
a conductive adhesive applied to a coupled surface between the sleeve and the base.

2. The spindle motor as set forth in claim 1, wherein the conductive adhesive is an anisotropic conductive film (ACF) applied in a solution state.

3. The spindle motor as set forth in claim 2, wherein the ACF is applied to the coupled surface between the sleeve and the base to bond therebetween by a thermo-compression method.

4. The spindle motor as set forth in claim 3, wherein the thermo-compression method is performed in a range of 250 to 300° C.

5. The spindle motor as set forth in claim 2, wherein the ACF is applied to the coupled surface between the sleeve and the base and has a vertical ultrasonic wave applied thereto, such that heat is spontaneously generated, thereby bonding between the sleeve and the base.

6. The spindle motor as set forth in claim 2, wherein the ACF in the solution state is applied to a bonded surface of the sleeve or the base in a dispensing or spray scheme.
